(19) United States
(12) Patent Application Publication
(10) Pub. No.: US 2026/0100387 A1
(43) Pub. Date: Apr. 9, 2026

(54) SINGLE CHANNEL LIQUID MEMBRANE CELL ASSEMBLIES

(71) Applicant: Skip Technology, Inc., Portland, OR (US)

(72) Inventors: Brennan Lonn Gantner, Portland, OR (US); Madisen Wynn McCleary, Portland, OR (US); Timothy Henry Kieltyka, Portland, OR (US); Benjamin Paul Brown, Portland, OR (US)

(73) Assignee: Skip Technology, Inc., Portland, OR (US)

(21) Appl. No.: 19/353,021

(22) Filed: Oct. 8, 2025

Related U.S. Application Data
(60) Provisional application No. 63/705,445, filed on Oct. 9, 2024.

(51) Int. Cl. H01M 8/04186; H01M 4/86; H01M 8/04082; H01M 8/18

(52) U.S. Cl. CPC H01M 8/04186; H01M 4/8605; H01M 8/04201; H01M 8/188

(57) ABSTRACT

Single channel liquid membrane cell assemblies and cell bodies are disclosed. In some embodiments, the single channel liquid membrane cell assembly includes an elongate cell body having an elongate opening, a first bipolar plate adjacent the cell body, and a first gas diffusion electrode disposed between the cell body and the first bipolar plate. The first gas diffusion electrode spans across the entire length and width of the elongate opening of the cell body. The single channel liquid membrane cell assembly additionally includes a second bipolar plate adjacent the cell body such that the cell body is disposed between the first and second bipolar plates. The elongate opening horizontally defines an open area and the first gas diffusion electrode and the second bipolar plate vertically define the open area therebetween.

### CROSS-REFERENCE TO RELATED APPLICATIONS

This application claims the benefit of U.S. Provisional Patent Application No. 63/705,445 filed on October 9, 2024 and entitled “Single Channel Liquid Membrane Cell Assemblies.” The complete disclosure of the above application is hereby incorporated by reference for all purposes.

### BACKGROUND OF THE DISCLOSURE

Mixing chambers or membrane cells for fuel cells and flow batteries typically involve two chemicals separated by a semi-permeable membrane. The membrane must allow protons to pass through but force electrons to travel around the system, through an electrical load, to perform work. However, the semi-permeable membrane is generally the weak point of the above fuel cells and flow batteries because of their high costs, low life span, and limited performance.

Membraneless systems (sometimes referred to as “liquid membrane systems”) eliminate the semi-permeable membrane and allow the fuel and electrolyte to flow alongside each other, with similar speeds to achieve minimal mixing, and then separated into different outlet ports once leaving the mixing cell or area. However, previous membraneless systems suffer from several problems. For example, electrolytes and fuel fluids can have more than minimal mixing resulting in a decrease in system efficiency and/or permanent damage to the catalyst. Additionally, in a bromine/hydrogen bromide membraneless cell, bromine is converted to hydrogen bromide along the cathode surface (where electrons are available) resulting in a physical and electrical barrier to the remaining bromine in the fluid flow that makes further conversion of fuel more difficult. Moreover, as fluids move through a liquid membrane cell, perturbations (whether deliberately instigated or not) can begin to dominate motion resulting in a decrease in effectiveness of the cell and/or mixing between the fuel and electrolyte fluids.

What is therefore desired are membraneless cell assemblies that minimize mixing of the electrolyte and fuel fluid(s), increase fuel conversion per unit length of the mixing chamber, increase amount of electrical power delivered per unit length of the mixing chamber, reduce the amount of electrical resistance across the mixing chamber, and/or maintain laminar flow in the mixing cell or area.

### BRIEF DESCRIPTION OF THE DRAWINGS

FIG. 1 is an isometric view of an example of a single channel liquid membrane cell assembly of the present disclosure.

FIG. 2 is an exploded view of the single channel liquid membrane cell assembly of FIG. 1, excluding fasteners shown in FIG. 1.

FIG. 3 is a top isometric view of an example of a cell body of the single channel liquid membrane cell assembly of FIG. 1.

FIGS. 4-5 are bottom isometric views of the cell body of FIG. 3.

FIG. 6 is a sectional view of the cell body of FIGS. 3-5 taken along lines 6—6 in FIG. 3.

FIG. 7 is a sectional view of the single channel liquid membrane cell assembly of FIG. 1.

FIG. 8 is a partial view of FIG. 6 illustrating fluid flow through the single channel liquid membrane cell assembly of FIG. 1.

FIG. 9 is an isometric view of another example of the single channel liquid membrane assembly of the present disclosure.

FIG. 10 is an exploded view of the single channel liquid membrane cell assembly of FIG. 9, excluding fasteners shown in FIG. 1.

FIG. 11 is a sectional view of the single channel liquid membrane cell assembly of FIG. 9.

FIG. 12 is a bottom isometric view of an example of a bipolar plate of the single channel liquid membrane assembly of FIG. 9.

FIG. 13 is a bottom isometric view of an example of a cell body of the single channel liquid membrane assembly of FIG. 9.

### DETAILED DESCRIPTION OF THE DISCLOSURE

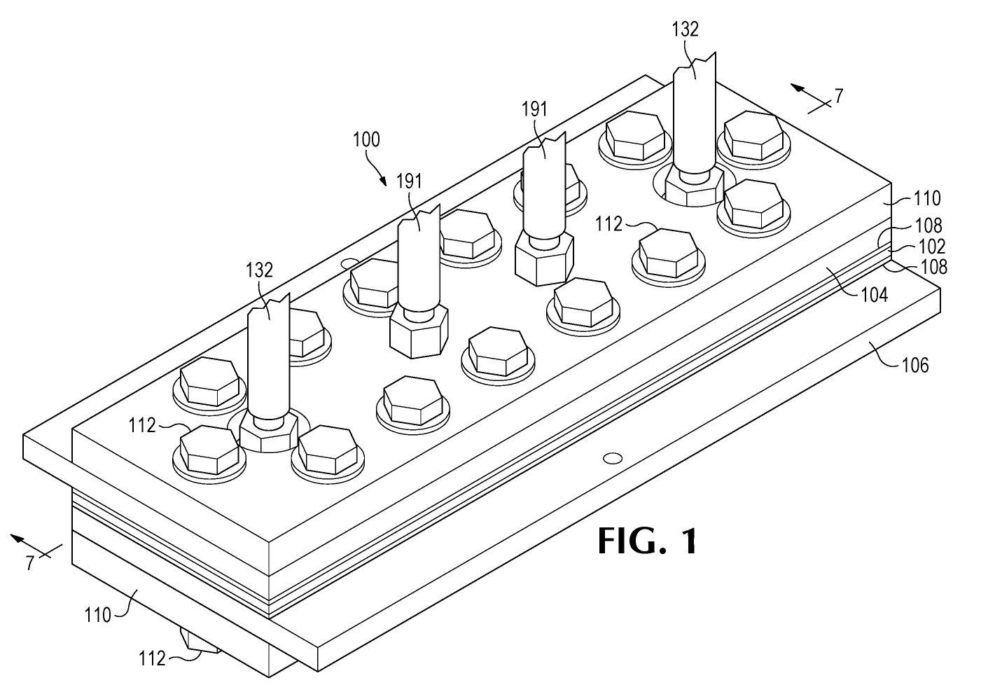

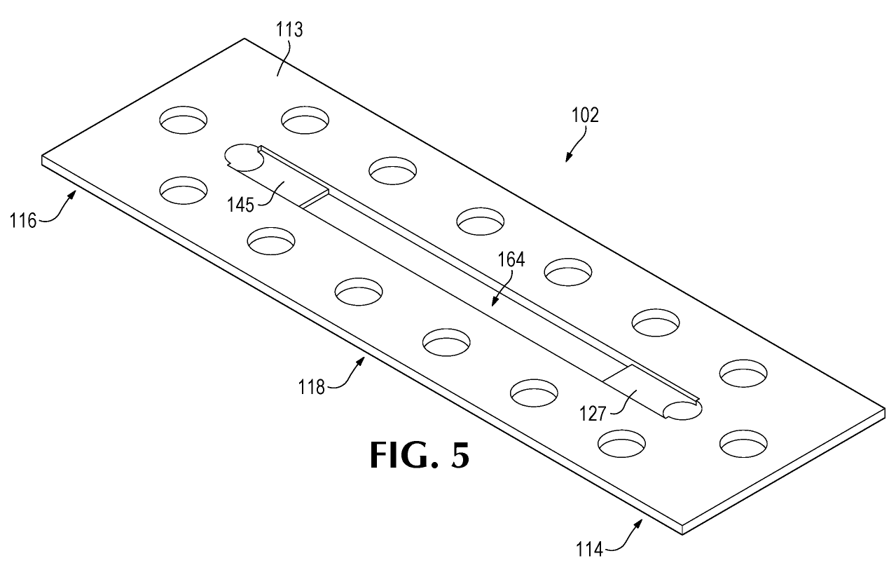

Referring to FIGS. 1-7, an example of a liquid flow battery cell or liquid membrane cell assembly 100 is shown. Unless explicitly excluded, liquid membrane cell assembly may additionally, or alternatively, include one or more components of the other liquid membrane cell assemblies of the present disclosure.

Liquid membrane cell assembly 100 includes a frame, skeleton, or cell body 102, a first bipolar plate 104, one or more gas diffusion electrodes (GDEs) 105, a second bipolar plate 106, sealing gaskets 108, clamping or end plates 110, and fasteners 112 (e.g., bolts, nuts, washers, and/or other components for clamping). In the example shown in FIGS. 1-7, cell body 102, first bipolar plate 104, GDEs 105, second bipolar plate 106, sealing gaskets 108, and end plates 110 are elongate and is a unitary piece manufactured, for example, via 3D printing and/or mold injection. However, other examples may include non-planar and/or non-elongate shapes for one or more (or all) of the above components. Additionally, or alternatively, one or more of the above components may be manufactured via any suitable other methods.

Cell body 102 includes a planar elongate base 113 having an inlet end portion 114, an outlet end portion 116, and a central portion 118 disposed between the inlet and outlet end portions. The portions may be attached to each other and/or formed with each other. Cell body 102 may be made of any suitable material(s), such as one or more plastic materials (e.g., polyvinylidene fluoride or polytetrafluoroethylene).

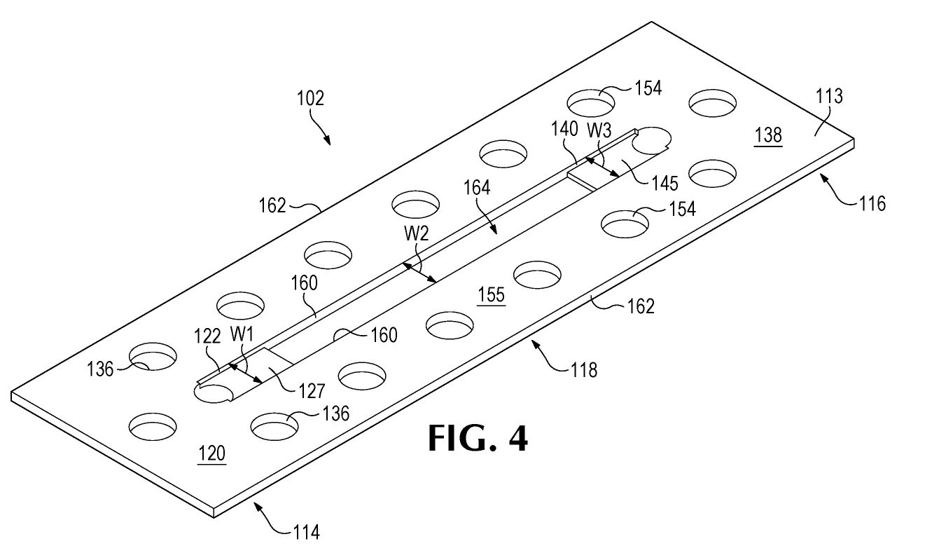

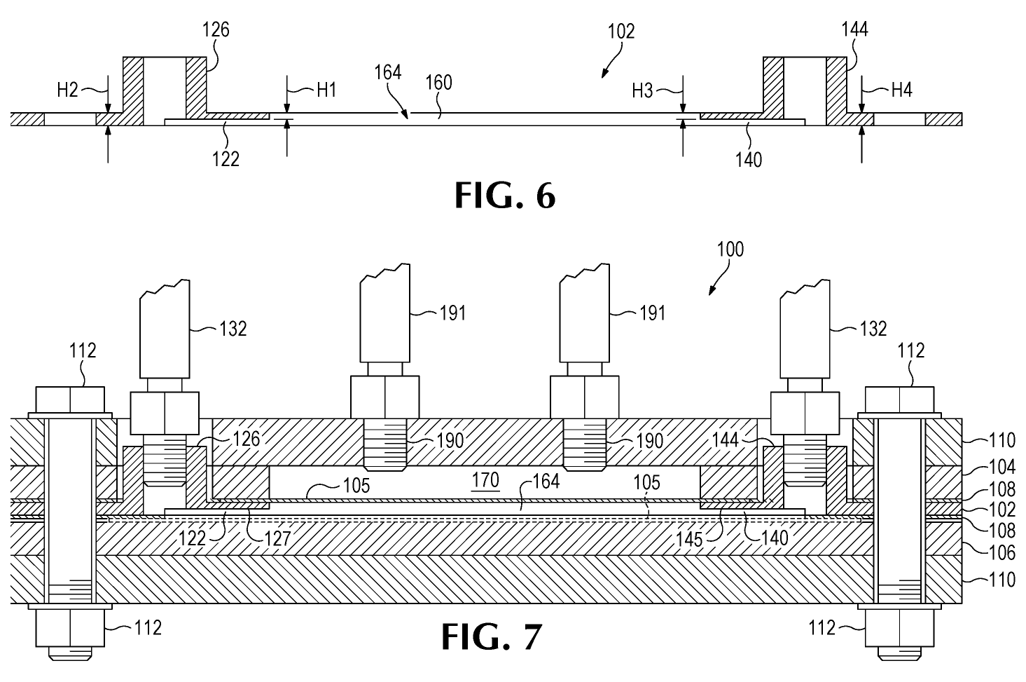

Inlet end portion 114 includes an inlet body 120 having a fuel inlet channel 122 and a fuel inlet port 126 that is accessible external the inlet body. Fuel inlet port 126 is fluidly connected to fuel inlet channel 122. A recessed part 127 of inlet body 120 that is between fuel inlet port 126 and central portion 118 has a height H1 (or thickness) that is less than a height H2 (or thickness) of adjacent part(s) or the remainder of the inlet body to form fuel inlet channel 122. In the example shown in FIGS. 4-6, H1 is half or about half of H2. Additionally, recessed part 127 has a width W1. In the example shown in FIGS. 4-6, width W1 is the same or about the same as width W2 of the elongate opening of the cell body, as further discussed below. As best shown in FIGS. 6-7, recessed part 127 includes a recessed portion of port 126 that is closer to the central portion to allow for fluid communication with elongate opening 164.

In the example shown in FIGS. 1-7, fuel inlet port 126 is perpendicular to fuel inlet channel 122. However, other examples of fuel inlet port 126 may be non-perpendicular to the fuel inlet channel. Fuel inlet port 126 may include threads and/or a tube fitting (not shown) and/or other connection structures that allow connection to a fuel inlet conduit 132. Those conduits may be connected to supply containers and/or tanks and/or upstream liquid membrane cell assemblies. Additionally, inlet body 120 includes apertures 136 to receive fasteners 112.

Similarly, outlet end portion 116 includes an outlet body 138 having a fuel outlet channel 140 and a fuel outlet port 144 that is accessible external the outlet body. A recessed part 145 of outlet body 138 that is between central portion 118 and fuel outlet port 144 has a height H3 (or thickness) that is less than a height H4 (or thickness) of adjacent part(s) or the remainder of the outlet body to form fuel outlet channel 140. In the example shown in FIGS. 4-6, H3 is half or about half of H4. Additionally, recessed part 145 has a width W3. In the example shown in FIGS. 4-6, width W3 is the same or about the same as width W2 of the elongate opening of the cell body, as further discussed below. As best shown in FIGS. 6-7, recessed part 145 includes a recessed portion of port 144 that is closer to the central portion to allow for fluid communication with elongate opening 164.

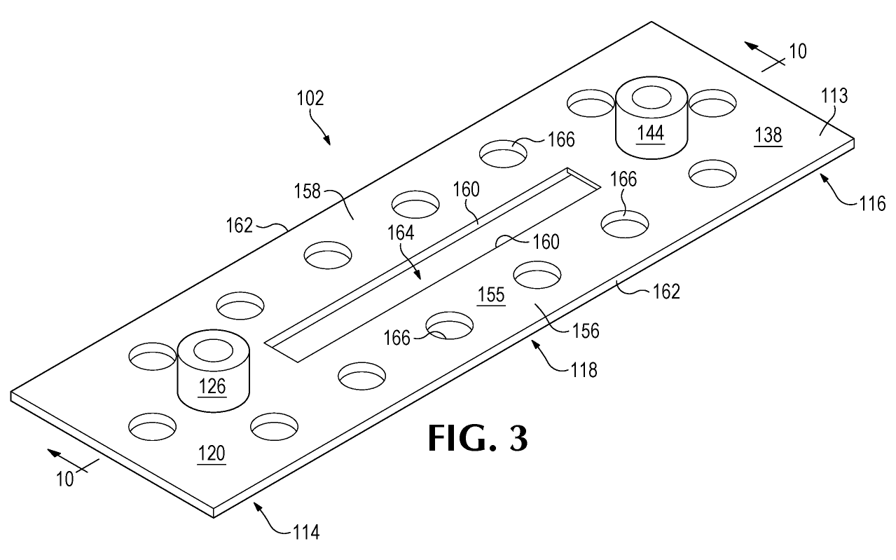

Additionally, as best shown in FIG. 6, fuel inlet channel 122 and fuel outlet channel 140 are aligned with each other and/or are co-planar and/or co-axial. Outlet body 138 also includes a fuel outlet port 144, which is accessible external the outlet body. Fuel outlet port 144 is fluidly connected to fuel outlet channel 140. In the example shown in FIGS. 1-7, fuel outlet port 144 is perpendicular to fuel outlet channel 140. However, other examples of the fuel outlet port may be non-perpendicular to the fuel outlet channel. Fuel outlet port 144 may include threads and/or a tube fitting (not shown) and/or other connection structures that allow connection to a fuel outlet conduit 148. Those conduits may be connected to output containers and/or tanks and/or downstream liquid membrane cell assemblies. Moreover, outlet body 138 includes apertures 154 to receive fasteners 112. In the example shown in FIGS. 3-6, cell body 102 includes only a single fuel inlet port, only a single fuel inlet channel, only a single fuel outlet port, and only a single fuel outlet channel without additional inlet port(s), outlet port(s), inlet channel(s), and outlet channel(s). Thus, liquid membrane cell assembly 100 may also be referred to as a “single channel liquid membrane cell assembly.”

Central portion 118 includes a central body 155 having a proximal bridge member 156 and a distal bridge member 158. The proximal and distal bridge members are spaced and opposed from each other. Proximal bridge member 156 and distal bridge member 158 connect inlet body 120 and outlet body 138. In the example shown in FIGS. 1-8, only the proximal and distal bridge members connect the inlet and outlet bodies. The proximal bridge member and distal bridge member each includes an inner wall 160 and an outer wall 162 opposed the inner wall. The inner walls of the bridge members face each other, while the outer walls face away from each other. Inlet body 120, outlet body 138, proximal bridge member 156, and distal bridge member 158 collectively and define (or horizontally define) a single elongate opening or open area 164 therebetween. In other words, the borders of open area 164 are formed by proximal bridge member 156 and distal bridge member 158 and by inlet body 120 and outlet body 138. Additionally, open area 164 is vertically defined between the gas diffusion electrode and the second bipolar plate, as further discussed below. Open area 164 fluidly connects the fuel inlet channel of the inlet end portion with the fuel outlet channel of the outlet end portion. In other words, the fuel inlet channel is fluidly connected to the fuel outlet channel only through the open area. Proximal and distal bridge members 156 and 158 additionally include apertures 166 to receive fasteners 112.

First and second bipolar plates 104 and 106 (collectively bipolar plates 107) each includes a planar bipolar plate base 168. First bipolar plate 104 additionally includes an elongate opening 170 that corresponds with elongate opening 164 of cell body 102 and holes 172 to receive the fuel inlet and outlet ports of the cell body. Bipolar plates 107 also include a plurality of apertures 174 to receive fasteners 112. Each of the bipolar plates may be an anode or a cathode. In the example shown in FIGS. 1-7, first bipolar plate 104 is an anode and second bipolar plate 106 is a cathode. Examples of suitable materials for the bipolar plates include graphite, graphene, metal alloys with or without coatings, or other carbon-based materials. An electrical circuit (not shown) may be coupled to one end of the cathode and to the anode at the opposite end. The electrical circuit may include current collector(s), resistor(s), capacitor(s), transformer(s), and/or other suitable components.

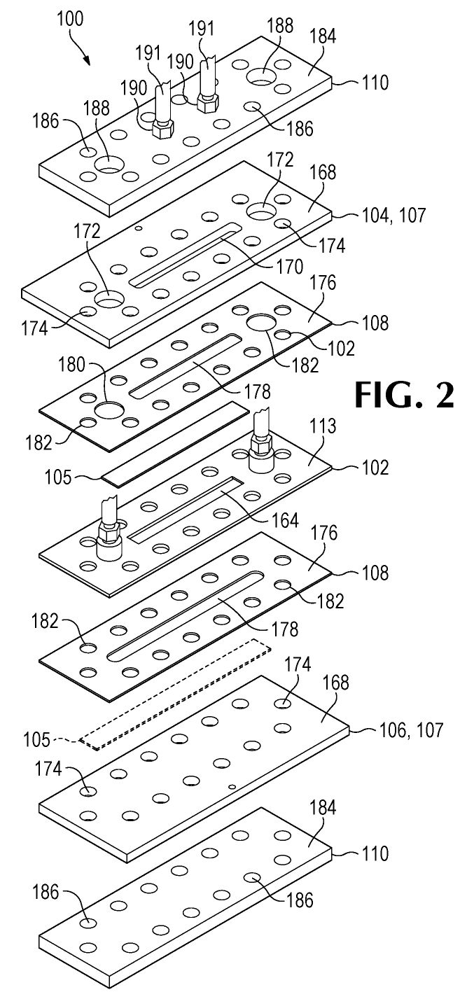

Gas diffusion electrode 105 is planar and sized to cover or span across the entire length and width of the elongate opening of the cell body and/or one or more of bipolar plates 104 and 106. In other words, the gas diffusion electrode has a length that is greater than the length of the elongate opening and a width that is greater than the width of the elongate opening. Examples of suitable materials for the gas diffusion electrode include carbon paper, carbon cloth, free-standing carbon composite layers, etc. In some embodiments, the gas diffusion electrode includes one or more catalyst materials, such as platinum, rhodium sulfide, etc. In the example shown in FIGS. 1-7, a gas diffusion electrode 105 is positioned between the cell body and the first bipolar plate to provide a liquid/gas barrier. In some embodiments, a second gas diffusion electrode 105 may be positioned between the cell body and the second bipolar plate (as best shown in FIG. 2) to, for example, increase power output of the liquid membrane cell assembly. The gas diffusion electrode(s) are secured to their positions via clamping or attaching of the various components together via fasteners 112.

Sealing gaskets 108 each includes a planar gasket base 176, an elongate opening 178 that corresponds with elongate opening 164 of cell body 102, and a plurality of apertures 182 to receive fasteners 112. The upper sealing gasket also includes holes 180 to receive the fuel inlet and outlet ports of the cell body. Sealing gaskets 108 may be made of any suitable materials, such as fluoroelastomer rubber, carbon-based materials, chemically resistant polymers, etc.

Top and bottom clamping or end plates 110 each includes an end plate base 184 and apertures 186 to receive fasteners 112. Additionally, top end plate includes holes 188 to receive the fuel inlet and outlet ports of the cell body, and one or more reactant gas ports 190. The reactant gas ports are in fluid communication with the elongate opening of the first bipolar plate. Reactant gas port(s) 190 may include threads and/or a tube fitting (not shown) and/or other connection structures that allow connection to a reactant gas conduit 191. Those conduits may be connected to supply containers and/or tanks and/or upstream liquid membrane cell assemblies. The end plates may be any suitable materials, such as acrylic, metal, etc.

Although liquid membrane cell assembly 100 is shown to include planar components that have rectangular prism shapes, one or more (or all) of those components may be non-planar and/or have shapes that are not rectangular prisms, such as having the shape of a cube, a cuboid, and a cylinder. Additionally, although elongate openings are shown those openings may be non-elongate (e.g., circular). Moreover, some of the components of liquid membrane cell assembly 100 may be combined. For example, one or more of the bipolar plates may include a gasket portion.

When the liquid membrane cell assembly of the present disclosure is used as a hydrogen bromide liquid flow battery cell, hydrogen is supplied as a reactant gas and liquid bromine is supplied as the fuel. Hydrogen bromide (HBr) is formed as an electrolyte product of the electrochemical reaction resulting from hydrogen protons reacting with molecular bromine (Br₂). The electrolyte product may be referred to as a “membrane” material for its function of localizing battery chemicals and electrochemical reactions to desired locations in the liquid membrane cell assembly and/or facilitating overall functioning of the battery cell.

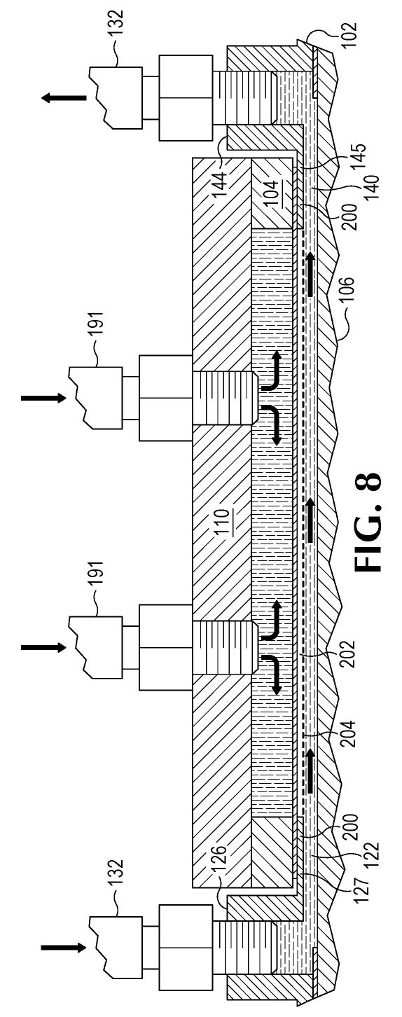

As best shown in FIG. 8, recessed parts 127 and 145 provide protrusions 200 that define a “shadow” region 202 therebetween. The protrusions may be described as borders that extend horizontally toward the center portion of the cell body and/or extend vertically toward the second bipolar plate. The protrusions constrain and localize the electrochemical reaction to below the shadow region by inhibiting the reaction from propagating to a greater spatial extent (i.e., in the direction of fuel flow) to regions in the liquid membrane cell assembly where the reaction would otherwise result in relatively diminished electron production and relatively greater generation of waste heat (i.e., in the shadow region or perpendicular to the fuel flow). Instead, at steady state, the electrochemical reaction forms substantially stable bubbles of hydrogen bromide electrolyte/membrane material 204 within the shadow region. In addition to providing a localized electrochemical reaction, the hydrogen bromide electrolyte/membrane material provides separation from the bromine fuel flow and inhibits efficiency-reducing material mixing.

The hydrogen bromide electrolyte/membrane material or “hydrogen bromide membrane” can remain substantially fixed and/or localized to the shadow region and thus may be considered a fixed or stable membrane. The height of the protrusions and the bottom surface of the gas diffusion electrode determine the height of the hydrogen bromide membrane formed. Although protrusions 200 are shown to be in the shape of a rectangular prism, one or more of those protrusions may alternatively be shaped as a cube, cuboid, sphere, hexagonal prism, cone, pyramid, tetrahedron, triangular prism, cylinder, or a portion of one or more of those shapes (not shown).

The present disclosure also includes a method of operating a liquid membrane cell assembly and/or generating electric power via a liquid membrane cell assembly. The method may include providing a gas diffusion electrode and one or more protrusions in a reaction chamber or open area of a liquid membrane cell assembly, flowing electrochemical fuel (e.g., bromine) into the open area on one side of the gas diffusion electrode, and flowing reactant gas (e.g., hydrogen) into a reaction gas area on the other side of the gas diffusion electrode and adjacent to the anode. In a steady state of operation, the electrochemical fuel reacts with the reactant gas to produce electrons and forms a hydrogen bromide membrane between the protrusions and below the gas diffusion electrode. The electrochemical fuel may be pulsed into the open area to disrupt formation of a membrane boundary layer that is adjacent to the cathode. No other gases or liquids (other than the liquid bromine and the hydrogen gas) are required or needed to be introduced or flowed into the liquid membrane cell assemblies of the present disclosure to generate electric power.

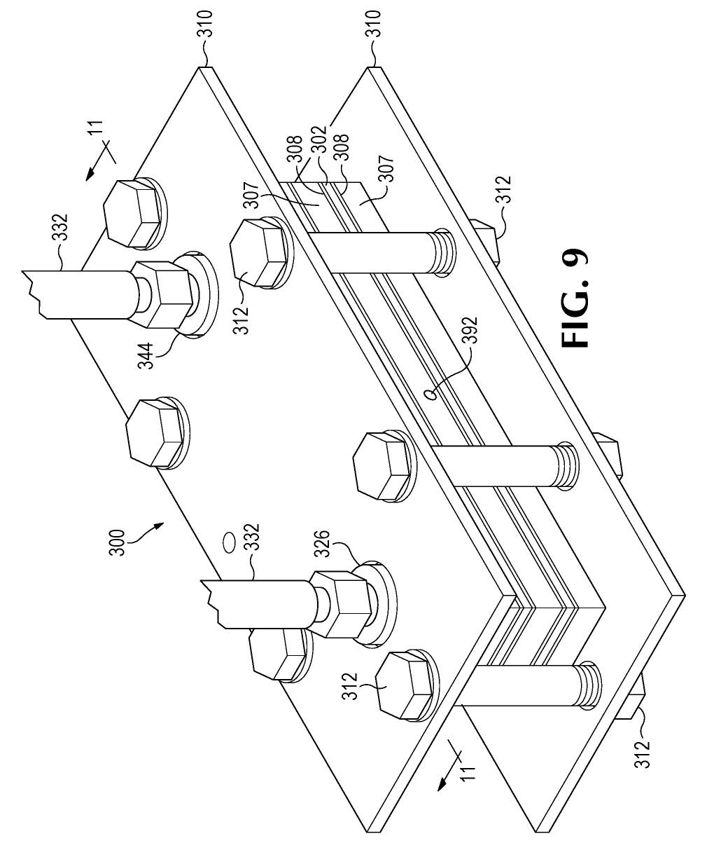

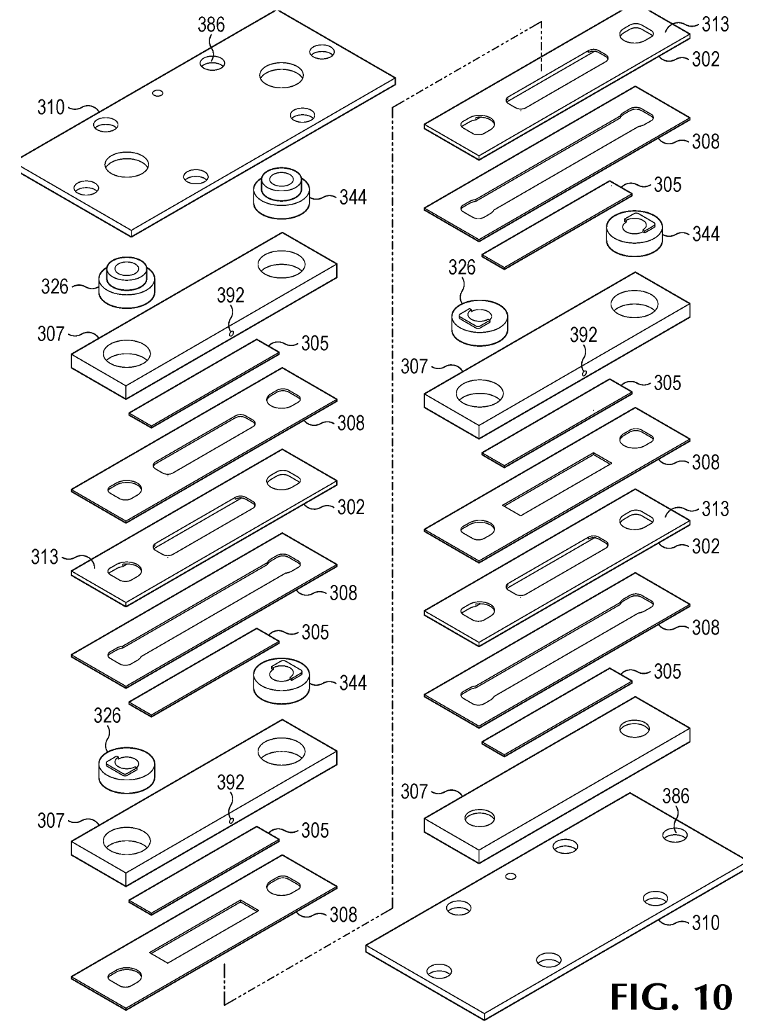

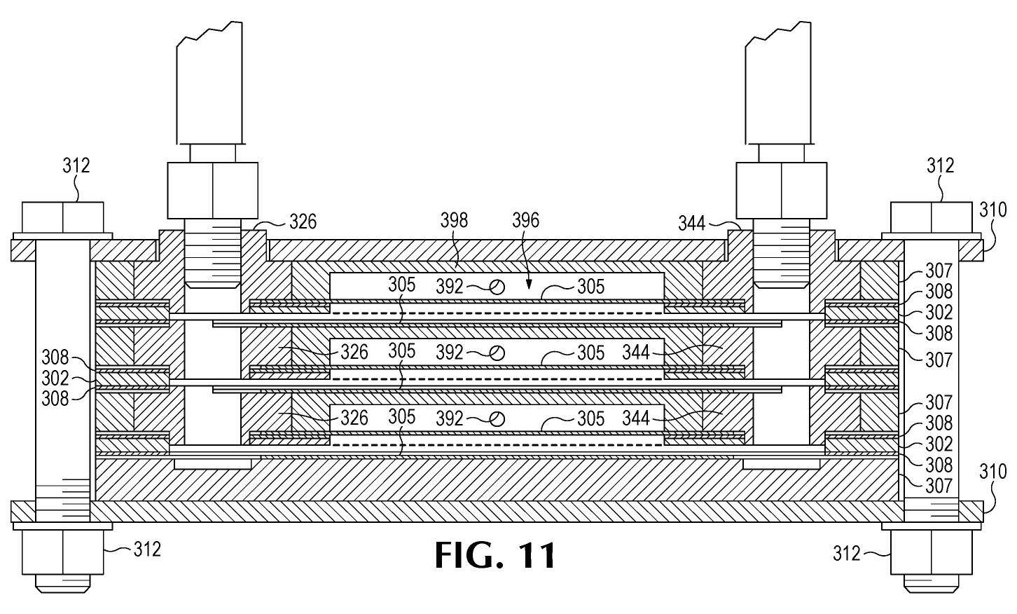

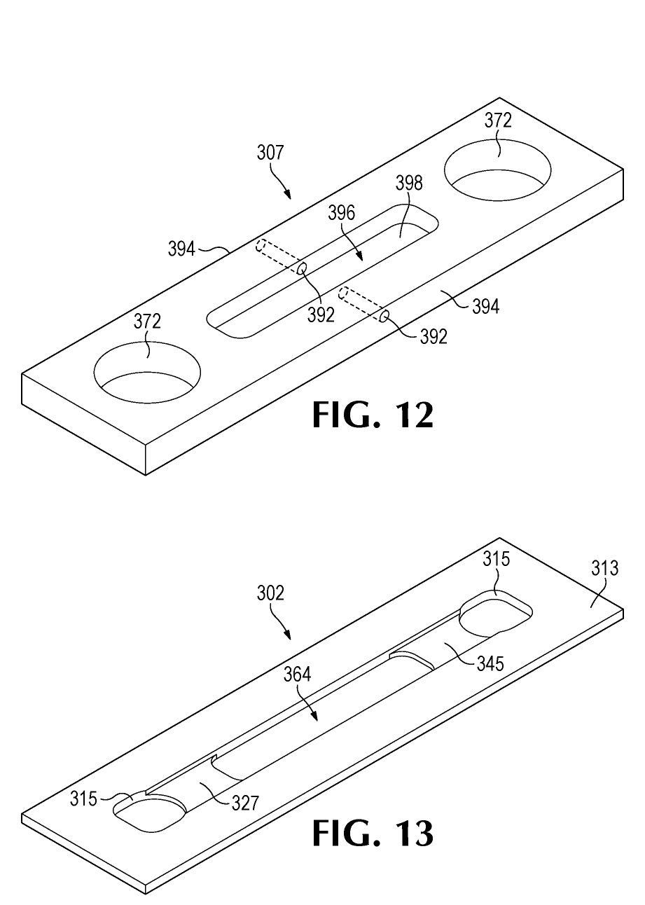

Referring to FIGS. 9-13, another example of liquid membrane cell assembly 100 is indicated at 300. Unless explicitly excluded, liquid membrane cell assembly may additionally, and/or alternatively, include one or more components of the other liquid membrane cell assemblies of the present disclosure. Some of the components of liquid membrane cell assembly 300 are labelled as 3xx that may be the same or similar to the components labeled XX of liquid membrane cell assembly 100 and thus may be described in lesser detail or no detail at all. For example, liquid membrane cell assembly includes cell bodies 302 that may have the same or similar structure as cell body 102. Additionally, bipolar plates 307 may have the same or similar structure as one or both bipolar plates 107.

Unlike the previous example, liquid membrane cell assembly 300 includes a plurality of cell bodies 302 that are sandwiched or stacked between bipolar plates 307, gas diffusion electrodes 305, sealing gaskets 308, clamping or end plates 310, and fasteners 312. Additionally, the fuel inlet and outlet ports of liquid membrane cell assembly 300 are not formed with elongate base 313 of each cell body 302. Instead those ports are attached to the elongate base of each cell body via the clamping of components with fasteners 312. Moreover, end plates 310 are larger than the other planar components, top end plate 310 (and bottom end plate 310) does not include any reactant gas ports, and only the end plates include apertures 386 for fasteners 312.

Furthermore, one or more of bipolar plates 307 includes reactant gas holes 392 on one or more opposed sides 394 that fluidly connect to a recessed open area 396. Unlike the bipolar plates of the previous example, the open area of bipolar plates 304 are “closed” from the top via a top containment wall 398 and are “open” in the bottom. In other words, the reactant gas that is injected into the recessed open area and through the reactant gas holes 392 cannot flow through and toward the top plate. In the example shown in FIGS. 9-13, all bipolar plates except for the bottom bipolar plate includes holes 392 and recessed open area 396. Although liquid membrane cell assembly 300 is shown to include three cell bodies 302, other examples of the liquid membrane cell assembly may include two, four, five, or more cell bodies each disposed between bipolar plates.

Numbered paragraphs that provide further examples of the liquid membrane cell assemblies of the present disclosure are shown below.

A1. A liquid flow battery cell, comprising:

an anode coupled to an electrical circuit having an electrical load;

a cathode coupled to the electrical circuit;

an inlet configured to receive an electrochemical fuel;

an outlet configured to output the electrochemical fuel;

a reaction chamber coupled to the inlet and to the outlet, the reaction chamber configured to host an electrochemical reaction; and

one or more protrusions arranged in the reaction chamber, each protrusion defining a shadow region in which, in a steady state during operation of the liquid flow battery cell, the electrochemical fuel reacts with a reactant gas to produce electrons and forms a substantially stable portion of an electrolyte, wherein the electrons are configured to be directed to the electrical circuit and power the electrical load.

A2. The liquid flow battery cell of paragraph A1, wherein the electrochemical fuel includes molecular bromine.

A3. The liquid flow battery cell of any one of paragraphs A1-A2, further comprising a source of hydrogen gas, wherein the liquid flow battery is configured to generate electrons by reacting hydrogen protons with bromine in the reaction chamber.

A4. The liquid flow battery cell of any one of paragraphs A1-A3, further comprising a catalyst, wherein the hydrogen protons are split from electrons by the catalyst.

A5. The liquid flow battery cell of any one of paragraphs A1-A4, wherein the electrolyte is comprised of hydrogen bromide.

A6. The liquid flow battery cell of any one of paragraphs A1-A5, wherein each of the one or more protrusions have a rectangular geometry.

A7. The liquid flow battery cell of any one of paragraphs A1-A6, wherein the cathode is configured to collect the electrons and direct the electrons to the electrical circuit for powering the electrical load.

B1. A method of operating a liquid flow battery cell, comprising:

providing an electrochemical fuel to a reaction chamber;

providing a reactant gas to the reaction chamber; and

reacting the electrochemical fuel with the reactant gas outside of a plurality of shadow regions defined by a plurality of protrusions arranged in the reaction chamber, wherein, in a steady state during operation of the liquid flow battery cell, the electrochemical fuel reacts with a reactant gas to produce electrons and forms a substantially stable portion of a membrane.

B2. The method of paragraph B1, wherein providing the electrochemical fuel to the reaction chamber comprises pulsing a flow of the electrochemical fuel provided to the reaction chamber to thereby disrupt formation of a membrane boundary layer proximate a cathode of the liquid flow battery cell.

### INDUSTRIAL APPLICABILITY

The present disclosure, including liquid membrane cell assemblies and components of those assemblies, is applicable to the fuel-processing, flow battery, and other industries.

The disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

What is claimed is:

1. A liquid membrane cell assembly, comprising:
an elongate cell body, including:
a planar elongate base having opposed first and second end portions and a central portion disposed between the first and second end portions,
a single elongate opening in the central portion, the elongate opening having opposed third and fourth end portions,
a fuel inlet port attached to, or formed with, the first end portion,
a fuel outlet port attached to, or formed with, the second end portion,
a fuel inlet channel that fluidly connects the fuel inlet port and the third end portion of the elongate opening, and
a fuel outlet channel that fluidly connects the fourth end portion of the elongate opening and the fuel outlet port, wherein the first end portion is free from one or more ports and one or more channels other than the fuel inlet port and the fuel inlet channel, and the second end portion is free from one or more ports and one or more channels other than the fuel outlet port and the fuel outlet channel;
a first bipolar plate adjacent the cell body;
a first gas diffusion electrode disposed between the cell body and the first bipolar plate, wherein the first gas diffusion electrode spans across the entire length and width of the elongate opening of the cell body; and
a second bipolar plate adjacent the cell body such that the cell body is disposed between the first and second bipolar plates, wherein the elongate opening horizontally defines an open area and the first gas diffusion electrode and the second bipolar plate vertically define the open area therebetween.

2. The assembly of claim 1, wherein a recessed part of the first end portion and an upper surface of the second bipolar plate vertically define the fuel inlet channel, and wherein a recessed part of the second end portion and the upper surface of the second bipolar plate vertically define the fuel outlet channel.

3. The assembly of claim 1, wherein the first bipolar plate includes a single elongate opening that corresponds with the elongate opening of the elongate cell body.

4. The assembly of claim 3, further comprising first and second end plates, wherein the cell body and first and second bipolar plates are disposed between the first and second end plates.

5. The assembly of claim 4, wherein the first end plate includes at least one reactant gas port, the at least one reactant gas port being in fluid communication with the elongate opening of the first bipolar plate.

6. The assembly of claim 3, wherein the planar base of the first bipolar plate includes at least one hole that is in fluid communication with the elongate opening of the first bipolar plate.

7. The assembly of claim 6, wherein the elongate opening of the first bipolar plate defines a longitudinal axis, and wherein the at least one hole is perpendicular to the longitudinal axis.

8. The assembly of claim 1, wherein the first gas diffusion electrode includes one or more catalysts.

9. The assembly of claim 1, further comprising a second gas diffusion electrode disposed between the cell body and the second bipolar plate, wherein the second gas diffusion electrode spans across the entire length and width of the elongate opening of the cell body.

10. The assembly of claim 1, wherein the first bipolar plate is an anode and the second bipolar plate is a cathode.

11. The assembly of claim 1, further comprising:
a third bipolar plate adjacent the second bipolar plate;
a second elongate cell body having a second elongate opening;
a third gas diffusion electrode disposed between the cell body and the third bipolar plate, wherein the second gas diffusion electrode spans across the entire length and width of the elongate opening of the cell body;
a fourth bipolar plate adjacent the second cell body such that the second cell body is disposed between the third and fourth bipolar plates, wherein the elongate opening horizontally defines a second open area and the second gas diffusion electrode and the fourth bipolar plate vertically define the second open area therebetween.

12. A cell body of a liquid membrane cell assembly, comprising:
a planar elongate base having opposed first and second end portions and a central portion disposed between the first and second end portions;
a single elongate opening in the central portion, the elongate opening having opposed third and fourth end portions;
a fuel inlet port attached to, or formed with, the first end portion;
a fuel outlet port attached to, or formed with, the second end portion;
a fuel inlet channel that fluidly connects the fuel inlet port and the third end portion of the elongate opening; and
a fuel outlet channel that fluidly connects the fourth end portion of the elongate opening and the fuel outlet port, wherein the first end portion is free from one or more ports and one or more channels other than the fuel inlet port and the fuel inlet channel, and the second end portion is free from one or more ports and one or more channels other than the fuel outlet port and the fuel outlet channel.

13. The cell body of claim 12, wherein a first part of the first end portion that is between the fuel inlet port and the third end portion of the elongate opening is recessed relative to at least a substantial part of the remainder of the first end portion.

14. The cell body of claim 13, wherein a third part of the second end portion that is between the fourth end portion of the elongate opening and the fuel outlet port is recessed relative to at least a substantial part of the remainder of the second end portion.

15. The cell body of claim 14, wherein the first part of the first end portion and the third part of the second end portion has the same height.

16. The cell body of claim 14, wherein the first part of the first end portion has half the height of the at least a substantial part of the remainder of the first end portion, and the third part of the second end portion has half the height of the at least a substantial part of the remainder of the second end portion.

17. The cell body of claim 14, wherein the elongate opening has a first width, and wherein at least one of the first part of the first end portion and the third part of the second end portion has the first width.

18. A method of generating electric power from a liquid membrane cell assembly having an anode, a cathode, a cell body disposed between the anode and the cathode, and a gas diffusion electrode disposed between the cell body and the anode, the cell body including a first elongate opening and protrusions that extend toward that opening, wherein the anode includes a second elongate opening that corresponds with the first elongate opening, and wherein the gas diffusion electrode is sized to span the elongate opening to create a liquid/gas barrier between the first and second elongate openings, and the method comprising:
flowing a single electrochemical fuel into the first elongate opening and on one side of the gas diffusion electrode; and
flowing a single reactant gas into the second elongate opening and on the other side of the gas diffusion electrode, wherein no other electrochemical fuel is flowed into the liquid membrane cell assembly and no other reactant gas is flowed into the liquid membrane cell assembly.

19. The method of claim 18, wherein the electrochemical fuel is bromine and the reactant gas is hydrogen gas.

20. The method of claim 18, wherein the single electrochemical fuel is pulsed into the first elongate opening.
